(19) United States
(12) Patent Application Publication
(10) Pub. No.: US 2012/0271817 A1
(43) Pub. Date: Oct. 25, 2012

(54) INFORMATION PROCESSING APPARATUS, INFORMATION PROCESSING METHOD, AND PROGRAM

(75) Inventors: Tadaaki KIMIJIMA, Tokyo (JP); Atsuko Shimoda, Tokyo (JP); Toshihiko Fushimi, Tokyo (JP); Kenichi Yamaura, Kanagawa (JP); Yoshihiko Nakazawa, Kanagawa (JP)

(73) Assignee: SONY CORPORATION, Tokyo (JP)

(21) Appl. No.: 13/447,535

(22) Filed: Apr. 16, 2012

(30) Foreign Application Priority Data
Apr. 21, 2011 (JP) 2011-095016

(51) Int. Cl. G06F 17/30; G09G 5/00

(52) U.S. Cl. 707/722; 345/619; 707/758; 707/E17.014

(57) ABSTRACT

Provided is an information processing apparatus including a related information acquisition unit for acquiring related information related to registered information registered in a schedule, and a display control unit for causing the related information, which has been acquired, to be displayed on a predetermined display unit according to an importance.

### BACKGROUND

The present technology relates to an information processing apparatus, an information processing method and a program, and more particularly, to an information processing apparatus, an information processing method and a program that enable to increase user convenience by using information registered in a schedule.

As applications installed in a personal computer, a mobile phone and the like, there is an application, a so-called scheduler, that inputs a user's scheduled action for the future, and that displays and manages the same on a calendar.

For example, there is an application for registering, with a scheduler, as a plan of a user, an action of the user determined based on a recommendation from a ToDo recommendation device that recommends an action of a user (for example, see JP 2009-99116A).

### SUMMARY

However, previously, if a user wanted to know detailed information regarding a future plan that the user had registered with a scheduler, the user had to carry out a search using the Internet, magazines or the like. For example, if there is a plan to go on a trip to Sendai in the near future, the user has to carry out a search regarding tourist sites in Sendai, hotels and the like.

The present technology has been made in view of the above circumstance, and enables to increase user convenience by using information registered in a schedule.

According to an embodiment of the present disclosure, there is provided an information processing apparatus which includes a related information acquisition unit for acquiring related information related to registered information registered in a schedule, and a display control unit for causing the related information, which has been acquired, to be displayed on a predetermined display unit according to an importance.

According to another embodiment of the present disclosure, there is provided an information processing method, performed by an information processing apparatus, including a related information acquisition unit and a display control unit, that processes information registered in a schedule, which includes acquiring, by the related information acquisition unit, related information related to registered information registered in the schedule, and displaying, by the display control unit, the related information, which has been acquired, on a predetermined display unit according to an importance.

According to another embodiment of the present disclosure, there is provided a program for causing a computer to execute a process including acquiring related information related to registered information registered in a schedule, and causing the related information, which has been acquired, to be displayed on a predetermined display unit according to an importance.

According to another embodiment of the present disclosure, related information related to registered information registered in a schedule is acquired, and the related information, which has been acquired, is displayed on a predetermined display unit according to an importance.

Additionally, the program can be provided by being transmitted by a transmission medium or by being recorded in a recording medium.

The information processing apparatus may be an independent apparatus or an internal block constituting a single device.

According to an embodiment of the present disclosure, user convenience can be increased by using information registered in a schedule.

### BRIEF DESCRIPTION OF THE DRAWINGS

FIG. 1 is a diagram showing an example configuration of an embodiment of an information processing system according to the present disclosure;

FIG. 2 is a diagram describing a function of a scheduler in a mobile terminal;

FIG. 3 is a diagram describing a function of the scheduler in a mobile terminal;

FIG. 4 is a block diagram showing an example functional configuration of the scheduler;

FIG. 5 is a flow chart describing a related information display control process;

FIG. 6 is a flow chart describing details of steps S3 and S4 of FIG. 5;

FIG. 7 is a flow chart describing the related information display control process in the case of add-in software;

FIG. 8 is a flow chart describing a number-of-clicks providing process;

FIG. 9 is a flow chart describing the related information display control process in the case of a single application; and

FIG. 10 is a block diagram showing an example configuration of an embodiment of a computer to which the present technology has been applied.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and configuration are denoted with the same reference numerals, and repeated explanation of these structural elements is omitted.

In the following, a mode of carrying out the present technology (hereinafter, an embodiment) will be described. Additionally, the explanation will be given in the following order.

1. First Embodiment (Example of Scheduler with Related Information Display Function)

2. Second Embodiment (Example where Related Information Display Function is Realised by Add-In Software)

3. Third Embodiment (Example of Software that Realises Only Related Information Display Function)

### First Embodiment

[Example Configuration of Information Processing System]

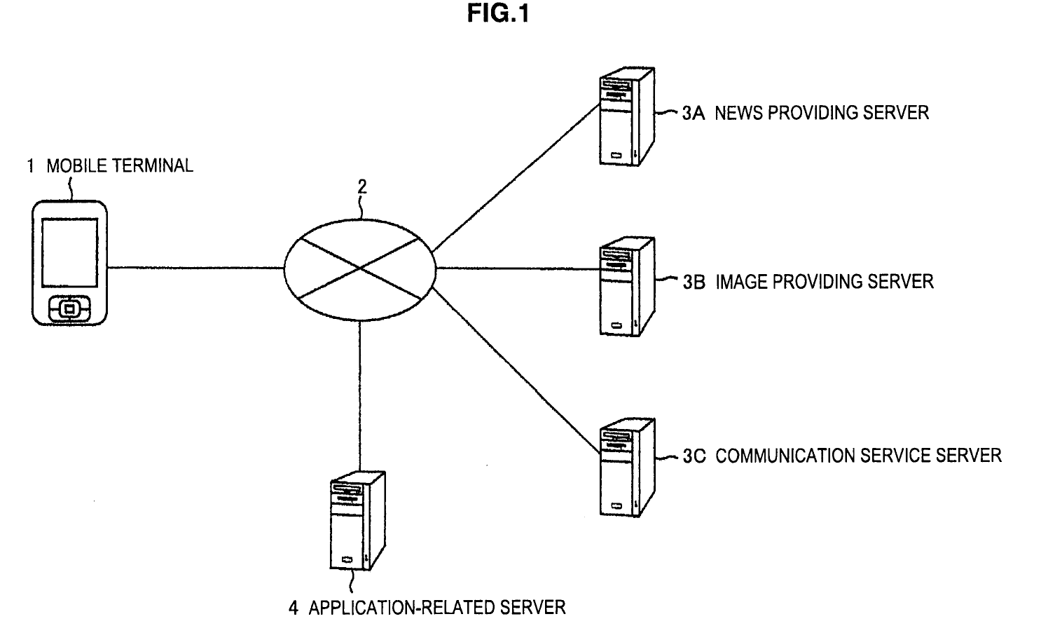

FIG. 1 shows an example configuration of an embodiment of an information processing system to which the present technology has been applied.

The information processing system of FIG. 1 is configured from a mobile terminal 1, and a news providing server 3A, an image providing server 3B, a communication service server 3C and an application-related server 4 that are connected with the mobile terminal 1 via a network 2. The network 2 here is configured from at least one of networks such as a mobile telecommunication network, a LAN, the Internet and the like.

Additionally, the mobile terminals 1 of a plurality of users can simultaneously access the news providing server 3A, the image providing server 3B, the communication service server 3C and the application-related server 4 and exchange data, but in the present embodiment, a case will be described, as a representative example, where there is only one mobile terminal 1.

The mobile terminal 1 is a highly functional mobile terminal called a smartphone, for example, which integrates a mobile phone and a mobile information terminal. Alternatively, the mobile terminal 1 may be a tablet terminal having a network connection function or a notebook (portable) personal computer, for example.

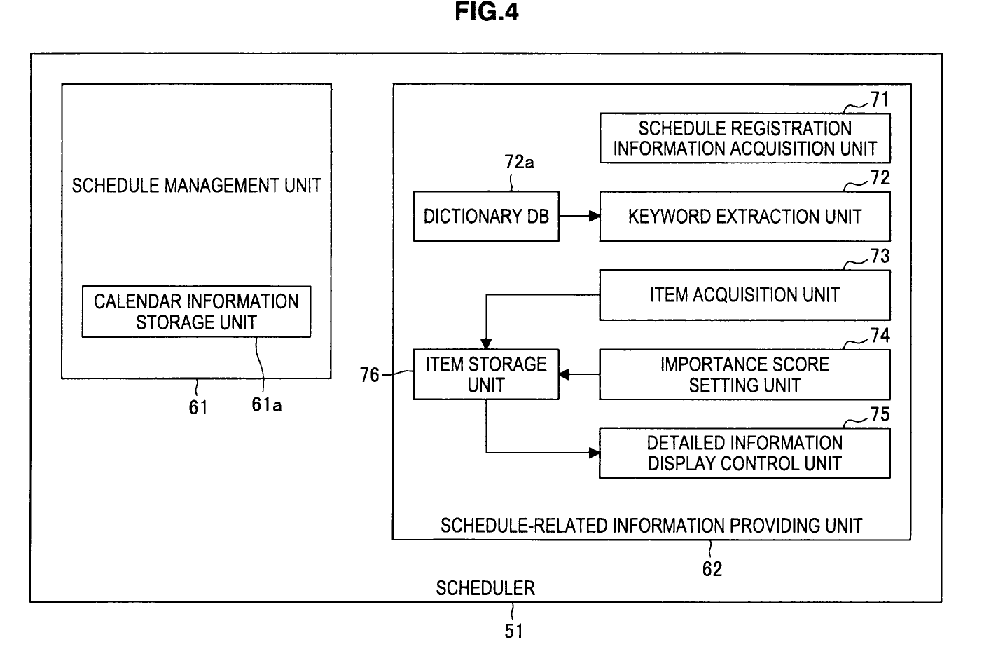

A scheduler 51 (FIG. 4), which is an application program for managing a schedule, is installed in the mobile terminal 1. The scheduler 51 may be pre-installed or may be downloaded from an application program providing site such as an application market.

The news providing server 3A is a service server that offers a service of providing news (information of news) to a mobile terminal 1 that is connected via the network 2. The news providing server 3A is operated by a newspaper publisher, a broadcast station, a news providing company or the like, for example.

The image providing server 3B is a service server that offers a service of providing images (data of images) to a mobile terminal 1 that is connected via the network 2. Images to be provided may be images uploaded from a plurality of users, companies (terminals of companies) or the like capable of accessing the image providing server 3B, such as a so-called image posting site, for example. Additionally, images to be provided include both moving images and still images.

The communication service server 3C is a service server that provides services such as RSS (RDF Site Summary/Really Simple Syndication), SNS (Social Networking Service), twitter and the like to a user (the mobile terminal 1 of a user) who is a registered member.

In the following, when not particularly distinguishing between the news providing server 3A, the image providing server 3B and the communication service server 3C, they will be collectively called the service server(s) 3.

The application-related server 4 is a server that provides information necessary for processing by the scheduler 51 executed at a mobile terminal 1. Additionally, depending on the execution condition of the scheduler 51, information from the application-related server 4 may not be necessary, and in that case, the application-related server 4 may be omitted.

In an information processing system configured in the above manner, the scheduler 51 of the mobile terminal 1 connects to various types of service servers 3 via the network 2 and performs exchange of predetermined information. Then, the scheduler 51 can provide to a user, not only a schedule management function, but also related information that is related to a plan registered in the schedule by displaying the same on the display of the mobile terminal 1, based on the information acquired from a service server 3.

[Description of Function of Scheduler 51]

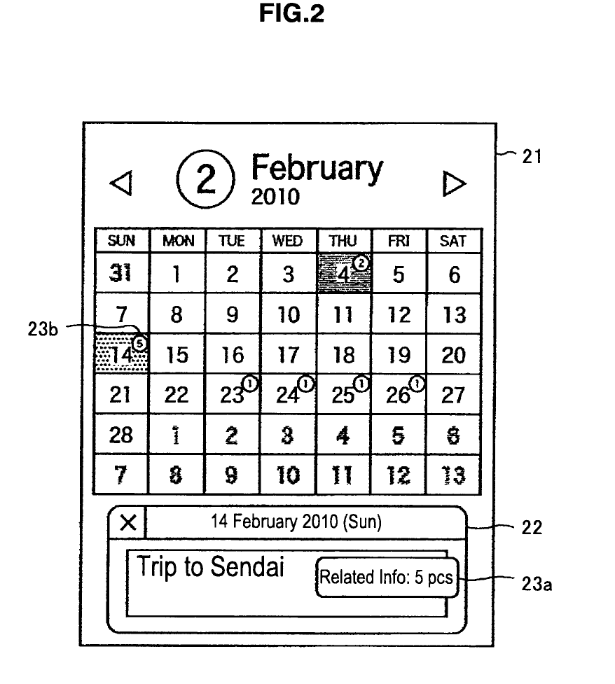

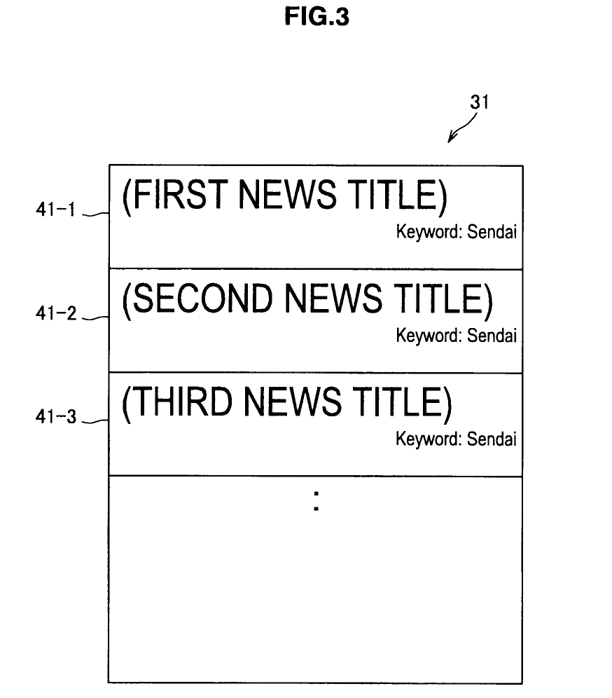

Next, a function of the scheduler 51 will be described first with reference to FIGS. 2 and 3.

FIG. 2 shows an example of a screen displayed by the scheduler 51 on the display of the mobile terminal 1.

When the scheduler 51 is started, a calendar screen 21 shown in FIG. 2 is displayed on the display of the mobile terminal 1.

The example of FIG. 2 is an example where the day the scheduler 51 is started is Feb. 4, 2010, and February 4th, which is the day of start, is displayed with a colour different from other days.

Additionally, the calendar screen 21 of FIG. 2 is in a mode of performing monthly display, and all the days of the current month of the current day are displayed, but the calendar screen 21 may also perform yearly display, weekly display, display of several days, display of one day, or the like.

Each day of the calendar screen 21 is a cell, and if a user wants to register a plan with a predetermined day, the user selects the cell with which registration of the plan is desired. The display of the mobile terminal 1 is a touch panel, for example, and selection of a cell can be performed by the user touching, with a finger, a desired day.

When a predetermined day within the calendar screen 21 is selected, the scheduler 51 displays a plan display screen 22, and the user can register (input) information which is the plan. Furthermore, if there is a plan that is already registered, the plan that is already registered is displayed on the plan display screen 22.

In the example of FIG. 2, the cell of February 14th is selected, and February 14th is displayed with a colour different from that of February 4th, which is the day of start, or any other day, and selection thereof is thereby indicated. Also, “Trip to Sendai” is registered, as the plan, in the plan display screen 22 displaying the plan for February 14th. This “Trip to Sendai” is registered information registered by the user as the plan for February 14th.

Besides the registered information registered by the user, a number-of-related-items display unit 23a indicating the number of pieces of information, searched by the scheduler 51, related to the registered information is displayed on the plan display screen 22. Additionally, in the following, the information, searched and acquired by the scheduler 51, related to the registered information will be called related information or an item.

In the example of FIG. 2, “Related Info: 5 pcs” is displayed in the number-of-related-items display unit 23a, and that five items related to the registered information of February 14th, “Trip to Sendai,” have been searched and acquired is indicated.

Also, in accordance with the display of “Related Info: 5 pcs” of the number-of-related-items display unit 23a, a number-of-related-items display unit 23b, which is an encircled number indicating the number of items, is displayed in the cell of February 14th on the calendar screen 21.

Encircled numbers shown in cells, on the calendar screen 21, other than that of February 14th are also to the same effect, and it is indicated, for example, that there are two items for February 4th which is the day of start, related to the registered information.

When the number-of-related-items display unit 23a on the plan display screen 22 is selected by being touched with a finger of the user, a related information-details display screen 31 shown in FIG. 3 is displayed.

That is, FIG. 3 shows an example of the related information-details display screen 31 that is displayed by the scheduler 51 on the display of the mobile terminal 1 when the number-of-related-items display unit 23a on the plan display screen 22 for February 14th is selected.

The related information-details display screen 31 displays keywords and titles of the items for the number of items displayed on the number-of-related-items display unit 23a. According to the related information-details display screen 31 of FIG. 3, keywords and titles of five items acquired as information related to the registered information of February 14th, “Trip to Sendai,” are displayed.

On the related information-details display screen 31, one item is displayed in one cell 41. In the case there are a plurality of items, they are displayed in the order of importance (scores) determined by the scheduler 51. In the example of FIG. 3, the importance of items of respective cells 41 are higher in the order of cells 41-1, 41-2, 41-3, . . . . Additionally, the number of items that the related information-details display screen 31 can display at one time (that is, the number of cells 41) differs depending on the size, resolution or the like of the display of the mobile terminal 1.

Although details of an item search method will be described later, the scheduler 51 performs morphological analysis, syntactic analysis or the like on the plan (character string) registered in the calendar screen 21 and extracts a keyword. Then, the scheduler 51 transmits the extracted keyword to a service server 3 such as the news providing server 3A or the image providing server 3B, and causes the service server 3 to search for information related to the keyword.

The service server 3 searches for information including in its title or description (detailed information) the received keyword, and returns the information to the scheduler 51. More specifically, for example, the news providing server 3A searches and returns news including the received keyword in its title or description (detailed information). The image providing server 3B searches and returns an image (a moving image or a still image) including the received keyword in its title or description (detailed information). The communication service server 3C searches and returns a tweet (a tweeted comment) including the received keyword in its title or description (detailed information).

The title of an item which is the information obtained as a result of a search as described above is displayed on the related information-details display screen 31, together with a keyword indicating the keyword with which the search was conducted.

The user views the title of the item and the keyword displayed in each cell 41 on the related information-details display screen 31, and if he/she wants to display the details of an item, selects (touches) the corresponding cell 41. In the case a predetermined cell 41 is selected, the scheduler 51 displays the detailed information of the item of the selected cell 41.

As described above, in addition to the normal function of managing (registration, viewing) the plan of a user, the scheduler 51 has a function of acquiring information related to a registered plan from a predetermined service server 3 and providing (displaying) the same to the user. The user can thereby view information related to his/her plan by simply using the normal schedule function, and the convenience is increased.

[Block Diagram of Functional Configuration of Scheduler 51]

FIG. 4 is a block diagram showing an example functional configuration of the scheduler 51.

The scheduler 51 includes a schedule management unit 61 and a schedule-related information providing unit 62. Furthermore, the schedule-related information providing unit 62 is configured from a schedule registration information acquisition unit 71, a keyword extraction unit 72, a dictionary DB 72a, an item acquisition unit 73, an importance score setting unit 74, a detailed information display control unit 75 and an item storage unit 76.

The schedule management unit 61 is a part that corresponds to a normal schedule management application, and displays the calendar screen 21 shown in FIG. 2, and displays a plan input by a user on the calendar or causes the calendar screen 21 to be editable and manages the schedule.

With the schedule management unit 61, plans of a user can be input in units of a predetermined number of days, such as one day, or in units of a predetermined number of hours, such as one hour, by further dividing the day, for example. A plan of a user which has been input is stored in a calendar information storage unit 61a as registered information.

The schedule-related information providing unit 62 performs, in cooperation with the schedule management unit 61, a function of acquiring, from a predetermined service server 3, information related to a plan of a user which has been registered, and providing (displaying) the same to the user.

The schedule registration information acquisition unit 71 acquires, from a calendar information storage unit 61a of the schedule management unit 61, registered information that is registered for the current day and a specific period ahead. In the case information that can be input at the schedule management unit 61 is divided into a plurality of sections such as a title, a details input section, a location (an address) and the like, the schedule registration information acquisition unit 71 performs acquisition while also identifying the section under which the information is input. For example, in the case the schedule registration information acquisition unit 71 has acquired information input under the section of a location, the information is recognized as the information of a location. Additionally, how far ahead of the current day is to be made the period for a search can be arbitrarily set by a user.

The keyword extraction unit 72 extracts keywords by performing language analysis, such as morphological analysis or syntactic analysis, on each piece of registered information acquired by the schedule registration information acquisition unit 71, based on a word dictionary or grammar rules for analysis stored in the dictionary DB 72a. The keyword extraction unit 72 may also classify extracted keywords into names of locations, names of people and the like. The dictionary DB 72a stores a word dictionary describing the way each word is written, part-of-speech information necessary for applying grammar for analysis or the like, and grammar rules describing, based on the information of each word described in the word dictionary, restrictions regarding lexical bundles or the like.

The item acquisition unit 73 transmits a keyword extracted by the keyword extraction unit 72 to the service server 3, and acquires information, related to the keyword, which has been returned as a result as an item (related information). The item acquisition unit 73 causes the item storage unit 76 to store, for each item acquired, the title of the item and the keyword.

The importance score setting unit 74 sets a score according to the importance for one or more items acquired by the item acquisition unit 73, and cause it to be stored in association with an item stored in the item storage unit 76. The score is higher for an item whose importance is thought to be higher.

According to the present embodiment, the importance score setting unit 74 sets the scores in such a way that the importance becomes higher for which users' interest is thought to be generally high according to the state of viewing of other users. More specifically, the importance score setting unit 74 exchanges data with the application-related server 4 managing the number of clicks for each item, and sets a score according to the number of clicks, which is the number of clicks (selection) on an item by other users.

Alternatively, for example, the importance score setting unit 74 may set the scores in such a way that the importance is higher for items related to immediate plans, that is, in such a way that the importance is higher as the number of days from the current day to the day of a plan is less. Furthermore, for example, the importance score setting unit 74 may set the scores in such a way that the importance is lower for an item related to the same plan that is repeatedly registered, such as a plan that is registered every week, or to a similar plan. With such setting of scores, the scheduler 51 can set scores using only the information that it holds, and thus exchange of data with the application-related server 4 is not necessary, thereby enabling to omit the application-related server 4.

The detailed information display control unit 75 performs control of displaying detailed information of an item selected by a user to be displayed, among a plurality of items displayed according to the importance, for example. To be specific, the detailed information display control unit 75 performs control of causing the related information-details display screen 31 of FIG. 3 to be displayed on a display, and also of causing detailed information of an item of a cell 41 selected by a user to be displayed on the display.

The item storage unit 76 stores, for each item acquired, the title of the item and the keyword. Furthermore, the item storage unit 76 also stores, in association with the title of the item and the keyword, an URL (Uniform Resource Locator) of the service server 3 for displaying the detailed information of the item.

[Flow of Related Information Display Control Process]

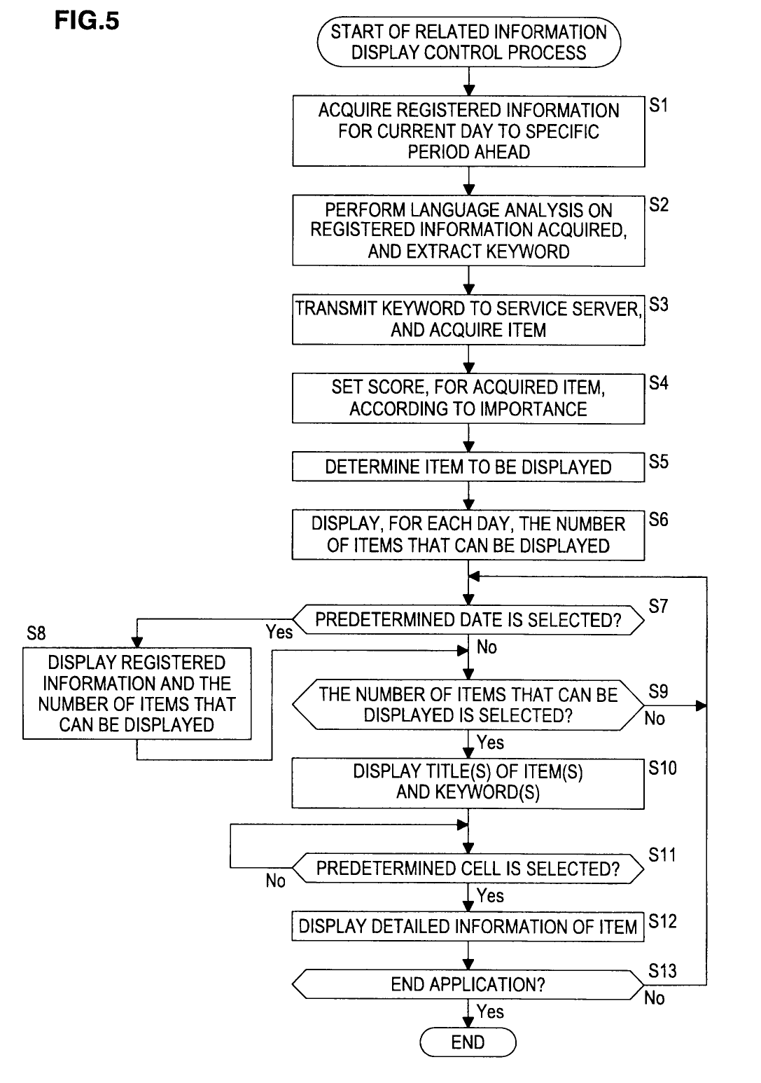

Next, a related information display control process, performed by the scheduler 51, for displaying related information based on registered information registered in a schedule will be described with reference to the flow chart of FIG. 5. This process is initiated when the scheduler 51 is started, for example.

First, in step S1, the schedule registration information acquisition unit 71 acquires registered information for the current day and a specific period ahead from the calendar information storage unit 61a.

In step S2, the keyword extraction unit 72 performs language analysis such as morphological analysis or syntactic analysis on each piece of registered information acquired by the schedule registration information acquisition unit 71, and extracts keywords.

In step S3, the item acquisition unit 73 transmits a keyword extracted by the keyword extraction unit 72 to the service server 3, and acquires an item (related information) related to the keyword, which has been returned as a result. Then, the item acquisition unit 73 causes the item storage unit 76 to store the title of the acquired item, the URL of its detailed information and the keyword.

In step S4, the importance score setting unit 74 sets a score that is in accordance with the importance, for one or more items acquired by the item acquisition unit 73. In the process of step S4, communication is performed with the application-related server 4 managing the number of clicks for each item, and a score that is in accordance with the number of clicks by other users is set for each item.

In step S5, the detailed information display control unit 75 determines an item to be displayed, based on the score set for each item. For example, the detailed information display control unit 75 hides an item with a low score of below a predetermined threshold, and determines an item with a score of the predetermined threshold or higher as the item to be displayed. Alternatively, the detailed information display control unit 75 may determine the top N pieces (N>0) with high scores as the items to be displayed. In step S5, a process of deleting the title, the keyword and the like of an item determined to be hidden from the item storage unit 76 is also performed by the detailed information display control unit 75.

In step S6, the detailed information display control unit 75 causes the number of items that can be displayed to be displayed for each day on the calendar screen 21. That is, the detailed information display control unit 75 causes the number-of-related-items display unit 23b on the calendar screen 21 of FIG. 2 to be displayed.

In step S7, the detailed information display control unit 75 decides whether a predetermined date (the cell of the date) is selected on the calendar screen 21.

In the case it is decided in step S7 that a predetermined date is selected, the process proceeds to step S8, and the detailed information display control unit 75 displays registered information of the selected date and the number of items that can be displayed. That is, the detailed information display control unit 75 causes the plan display screen 22 that shows the registered information of the selected date, as shown in FIG. 2, to be displayed, and also causes the number-of-related-items display unit 23a that shows the number of items that can be displayed for the selected date.

On the other hand, in the case it is decided in step S7 that a predetermined date is not selected, or after the process of step S8, the process proceeds to step S9, and the detailed information display control unit 75 decides whether the number of items that can be displayed is selected. That is, whether the number-of-related-items display unit 23a is selected by the user or not is decided.

In the case it is decided in step S9 that the number of items that can be displayed is not selected, the process returns to step S7, and the process of steps S7 to S9 described above is repeated.

On the other hand, in the case it is decided in step S9 that the number of items that can be displayed is selected, the process proceeds to step S10, and the detailed information display control unit 75 displays, in the descending order of scores, on the related information-details display screen 31, keywords and titles of items corresponding to registered information of the selected date.

Then, in step S11, the detailed information display control unit 75 decides whether a predetermined cell 41 on the related information-details display screen 31 is selected. That is, the detailed information display control unit 75 decides whether the keyword and the title of one of a plurality of items displayed on the related information-details display screen 31 are selected.

In step S11, the process is suspended until it is decided that a predetermined cell 41 on the related information-details display screen 31 is selected. Then, in the case it is decided in step S11 that a predetermined cell 41 on the related information-details display screen 31 is selected, the detailed information display control unit 75 displays, in step S12, detailed information of an item corresponding to the selected cell 41.

In the case a predetermined cell 41 on the related information-details display screen 31 is selected, detailed information of an item corresponding to the selected cell 41 is displayed by the related information-details display screen 31 acquiring, from the item storage unit 76, an URL, which is the access destination of the detailed information of the item of the selected cell 41, and accessing the same.

In step S13, the scheduler 51 decides whether an instruction indicating the end of the application is issued. In the case it is decided in step S13 that an instruction indicating the end of the application is not issued, the process returns to step S7. The process of steps S7 to S13 described above is thereby repeated.

On the other hand, in the case it is decided in step S13 that an instruction indicating the end of the application is issued, the related information display control process is ended.

[Flow of Details of Process of Steps S3 and S4]

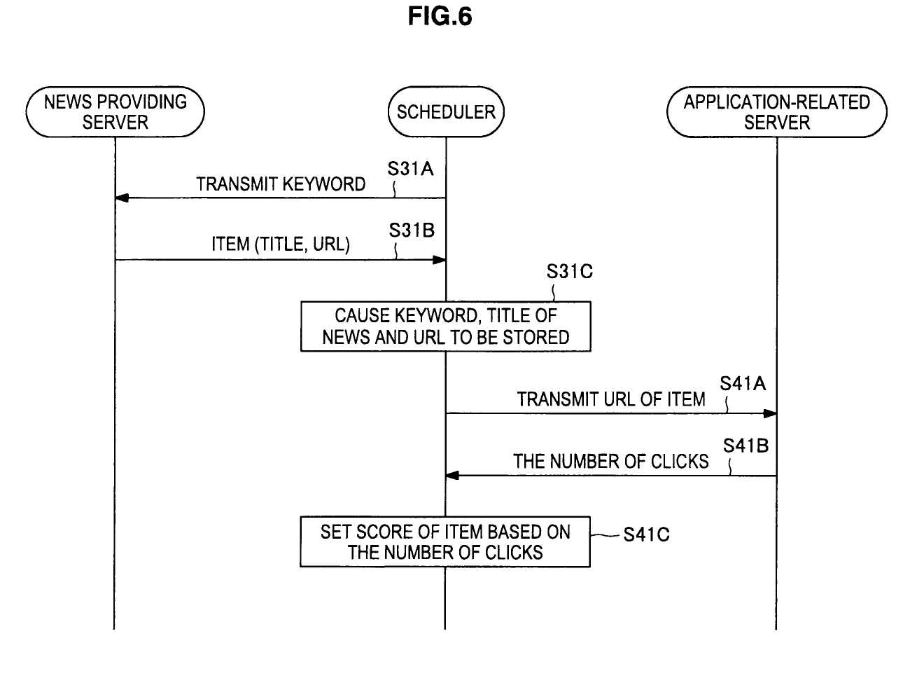

A flow of the scheduler 51 acquiring an item based on a keyword will be described with reference to the flow chart of FIG. 6. FIG. 6 is, in other words, a flow chart describing the details of steps S3 and S4 of FIG. 5, and particularly, shows a case of accessing the news providing server 3A as the service server 3.

First, in step S31A, the item acquisition unit 73 of the scheduler 51 transmits a keyword extracted by the keyword extraction unit 72 to the news providing server 3A, and instructs the news providing server 3A to search for news including the keyword.

In step S31B, the news providing server 3A searches for news including the received keyword, and transmits, as a search result, the title of the news which has been found and the URL of its detailed information (a detailed article) to the scheduler 51.

In step S31C, the item acquisition unit 73 of the scheduler 51 receives the item transmitted from the news providing server 3A, and causes the same to be stored in the item storage unit 76 in association with the keyword which was transmitted. That is, the item acquisition unit 73 stores, in the item storage unit 76, the title of the news and the URL of its detailed information transmitted from the news providing server 3A in association with the keyword which was transmitted.

The process of steps S31A to S31C described above corresponds to the process of step S3 of FIG. 5 described above. The process of steps S31A to S31C is performed for all the extracted keywords.

Then, in step S41A, the importance score setting unit 74 of the scheduler 51 transmits the URL of the detailed information of the news acquired to the application-related server 4.

The application-related server 4 manages the state of viewing of a large number of users for various types of services provided by various types of service servers 3. With respect to the news providing server 3A, the number of times the detailed information of news provided by the news providing server 3A has been viewed is stored as the number of clicks on the URL of the detailed information of the news.

In step S41B, the application-related server 4 receives the URL of the detailed information of the news transmitted from the scheduler 51, and transmits (returns) the number of clicks on the URL to the scheduler 51.

In step S41C, the importance score setting unit 74 of the scheduler 51 receives the number of clicks from the application-related server 4, and sets the score of the item based on the received number of clicks. For example, the importance score setting unit 74 sets a score 1 in response to a hundred clicks, or sets a score by referring to a table or the like in which the number of clicks within a predetermined range and a score are associated. Alternatively, the number of clicks itself may be made the score.

The process of steps S41A to S41C described above corresponds to the process of step S4 of FIG. 5 described above. The process of steps S41A to S41C is performed for all the items acquired.

As described above, according to the related information display control process described with reference to FIGS. 5 and 6, the item acquisition unit 73 acquires an item (related information) related to registered information registered in the scheduler 51 for within a specific period from the current day to a predetermined period ahead. Then, the number of items acquired is displayed in the cell of a corresponding day on the calendar. When the cell of a day in which the number of items is displayed is selected by a user, the plan display screen 22 of the selected day and the number-of-related-items display unit 23a indicating the number of items are displayed. When the user selects the number-of-related-items display unit 23a, the detailed information display control unit 75 causes the related information-details display screen 31 to be displayed. Detailed information of the items of the selected day is displayed, on the related information-details display screen 31, in accordance with the importance.

Accordingly, as with a normal scheduler, a user can view related information related to a registered plan by simply registering a plan in the scheduler 51. The burden of the user having to search for related information himself/herself can be thereby eliminated, and the convenience is increased.

Also, since related information is displayed according to the importance, even if a large number of pieces of related information are acquired for registered information registered in the scheduler 51, viewing can be performed efficiently from the most important one. Furthermore, in the above-described embodiment, the importance is set according to the state of viewing of other users, and thus viewing can be efficiently performed from the one in which interest of users is thought to be generally high.

### Second Embodiment

[Example of Process where Function is Provided as Add-in Software]

In the above-described embodiment, the scheduler 51 includes not only a normal schedule management function but also the related information display function of displaying related information of a plan registered in a schedule.

However, the related information display function may also be provided separately from the application of a normal schedule management function, as an application that is added in (added on) a normal scheduler.

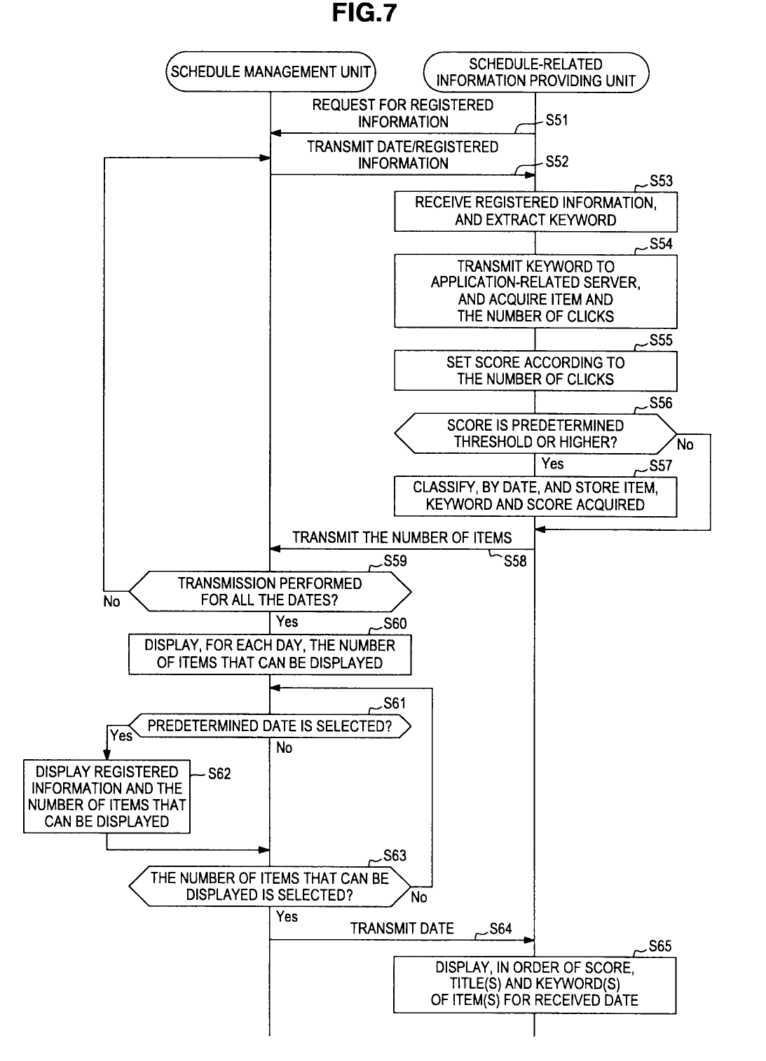

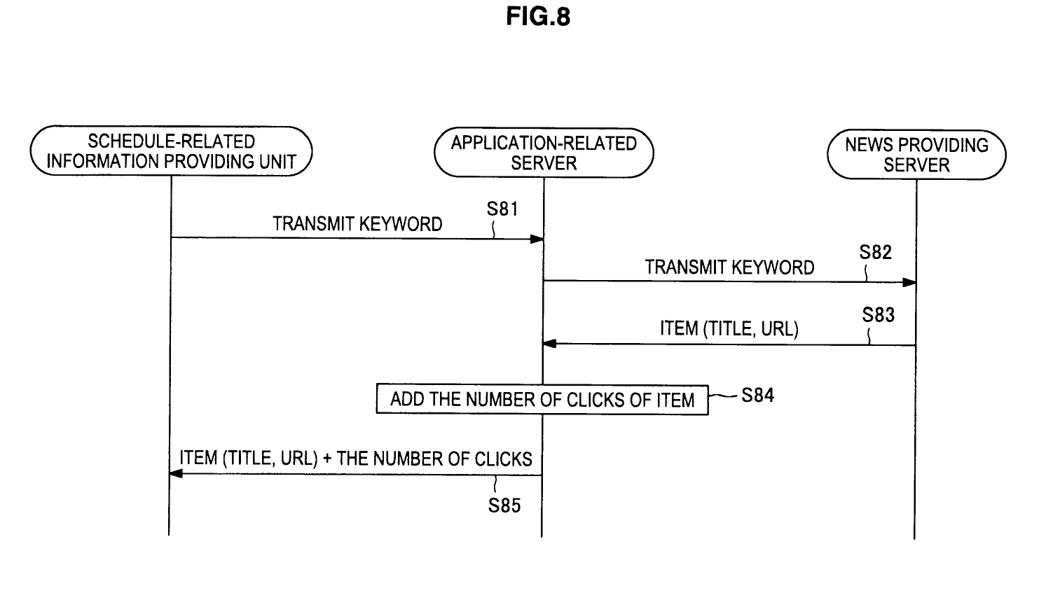

FIGS. 7 and 8 are flow charts describing the related information display function, for a case where the related information display function is provided as add-in software separate from the application of a normal schedule management function.

Additionally, in FIGS. 7 and 8, it is assumed that the schedule management unit 61 and the schedule-related information providing unit 62 are different applications, and that the schedule-related information providing unit 62 is software that is added in the schedule management unit 61.

First, in step S51 of FIG. 7, the schedule registration information acquisition unit 71 of the schedule-related information providing unit 62 requests the schedule management unit 61 for registered information for the current day to a specific period ahead.

In step S52, the schedule management unit 61 receives the request for registered information, and transmits to the schedule-related information providing unit 62 registered information of a predetermined day within the requested period together with the date.

In step S53, the schedule-related information providing unit 62 receives the registered information which has been transmitted, and extracts a keyword. That is, the schedule registration information acquisition unit 71 receives the registered information which has been transmitted, and supplies the same to the keyword extraction unit 72. The keyword extraction unit 72 extracts a keyword from the registered information which has been supplied.

Then, in step S54, the item acquisition unit 73 transmits the keyword extracted from the registered information to the application-related server 4, and acquires an item (the title of an item and the URL of detailed information) related to the keyword and the number of clicks returned as a result. Although details will be described later with reference to FIG. 8, in the second embodiment, both the item (the title of the item and the URL of detailed information) and the number of clicks are acquired from the application-related server 4.

In step S55, the importance score setting unit 74 sets a score of the item according to the acquired number of clicks.

In step S56, the importance score setting unit 74 decides, for each of items acquired, whether the score which has been set is a predetermined threshold or higher.

In the case the score which has been set is decided in step S56 to be a predetermined threshold or higher, the process proceeds to step S57, and the importance score setting unit 74 classifies the item acquired, the keyword and the score according to the date, and causes the item storage unit 76 to store the same.

On the other hand, in the case it is decided in step S56 that the score which has been set is below the predetermined threshold, the process of step S57 is skipped. An item with a low score (a score below the predetermined threshold) is thereby not stored in the item storage unit 76 and is hidden.

In step S58, the importance score setting unit 74 transmits, to the schedule management unit 61, as a reply with respect to the date for which the registered information has been transmitted in step S52, the number of items that can be displayed as the item of the registered information of the corresponding day.

In step S59, the schedule management unit 61 decides whether registered information has been transmitted with respect to all the dates within the requested period of the process of step S51.

In the case it is decided in step S59 that registered information is not yet transmitted for all the dates within the requested period, the process returns to step S52, and the process of steps S52 to S59 described above is repeated.

On the other hand, in the case it is decided in step S59 that registered information is transmitted for all the dates within the requested period, the process proceeds to step S60, and the schedule management unit 61 displays, for each day on the calendar screen 21, the number of items that can be displayed.

In step S61, it is decided whether a predetermined date (the cell of the date) is selected on the calendar screen 21.

In the case it is decided in step S61 that a predetermined date is selected, the process proceeds to step S62, and the schedule management unit 61 displays the plan display screen 22 and displays the registered information of the selected date and the number of items that can be displayed.

On the other hand, in the case it is decided in step S61 that a predetermined date is not selected, or after the process of step S62, the process proceeds to step S63, and the schedule management unit 61 decides whether the number of items that can be displayed is selected. That is, the schedule management unit 61 decides whether the number-of-related-items display unit 23a of the plan display screen 22 is selected by the user.

In the case it is decided in step S63 that the number of items that can be selected is not selected, the process returns to step S61, and the process of steps S61 to S63 described above is repeated.

On the other hand, in the case it is decided in step S63 that the number of items that can be displayed is selected, the process proceeds to step S64, and the schedule management unit 61 transmits the selected date to the schedule-related information providing unit 62.

In step S65, the detailed information display control unit 75 of the schedule-related information providing unit 62 receives the date which has been transmitted from the schedule management unit 61. Then, the detailed information display control unit 75 acquires the title(s) of the item(s) and the keyword(s) for the received date from the item storage unit 76, and displays the same by the related information-details display screen 31 in the descending order of scores.

The process of the detailed information display control unit 75 of the schedule-related information providing unit 62 after the related information-details display screen 31 is displayed is the same as the process of steps S11 and S12 of FIG. 5 described above, and explanation thereof will be omitted.

Additionally, according to the process of FIG. 7, as with the process of FIG. 5, in the case a predetermined date is selected, registered information and the number of items that can be displayed (the plan display screen 22 and the number-of-related-items display unit 23a) for the selected date are displayed, and in the case the number of items that can be displayed is selected, the related information-details display screen 31 is displayed.

However, the related information-details display screen 31 displaying the title of an item that can be displayed and a keyword for a selected date may also be displayed immediately after a predetermined date is selected.

[Flow of Process of Providing the Number of Clicks]

Step S54 of FIG. 7 is, unlike the first embodiment, a process where the item acquisition unit 73 acquires both an item related to a keyword and the number of clicks from the application-related server 4. Then, as the details of the process of step S54 of FIG. 7, a series of processes performed by the application-related server 4 and the service server 3 will be described with reference to the flow chart of FIG. 8. Additionally, also in FIG. 8, a case is described where access is performed to the news providing server 3A as the service server 3.

First, in step S81, the item acquisition unit 73 of the schedule-related information providing unit 62 transmits a keyword extracted from registered information to the application-related server 4.

In step S82, the application-related server 4 receives the keyword transmitted from the schedule-related information providing unit 62, and transmits the same to the news providing server 3A.

In step S83, the news providing server 3A receives the keyword which has been transmitted, and searches for an item corresponding to the keyword. Then, the news providing server 3A transmits the title of news, which is the item obtained as a result of the search, and the URL of its detailed information to the application-related server 4.

In step S84, the application-related server 4 receives the item which has been transmitted from the news providing server 3A, and acquires, from an internal management data storage unit for managing viewing information of users, the number of clicks for the received item and adds the same to the item.

Then, in step S85, the application-related server 4 transmits the item (the title of the news and the URL of its detailed information) corresponding to the keyword and the number of clicks therefor to the schedule-related information providing unit 62.

With the series of processes described above performed, the schedule-related information providing unit 62 can acquire an item related to a keyword and the number of clicks at the same time by transmitting a keyword extracted from registered information to the application-related server 4.

As described above, also when the schedule-related information providing unit 62 is an application that is added in a normal scheduler (the schedule management unit 61), a user can view related information related to a registered plan simply by registering a plan in another scheduler (the schedule management unit 61). The burden of the user having to search for related information himself/herself can be thereby eliminated, and the convenience is increased.

Additionally, in the first to third embodiments described, either of the method of FIG. 6 described as the first embodiment and the method of FIG. 8 described as the second embodiment may be adopted as the acquisition method of an item related to a keyword and the number of clicks.

### Third Embodiment

[Example of Software that Realises Only Related Information Display Function]

Next, an example of a process for a case where the schedule-related information providing unit 62 that realizes the related information display function is a single application (software) will be described.

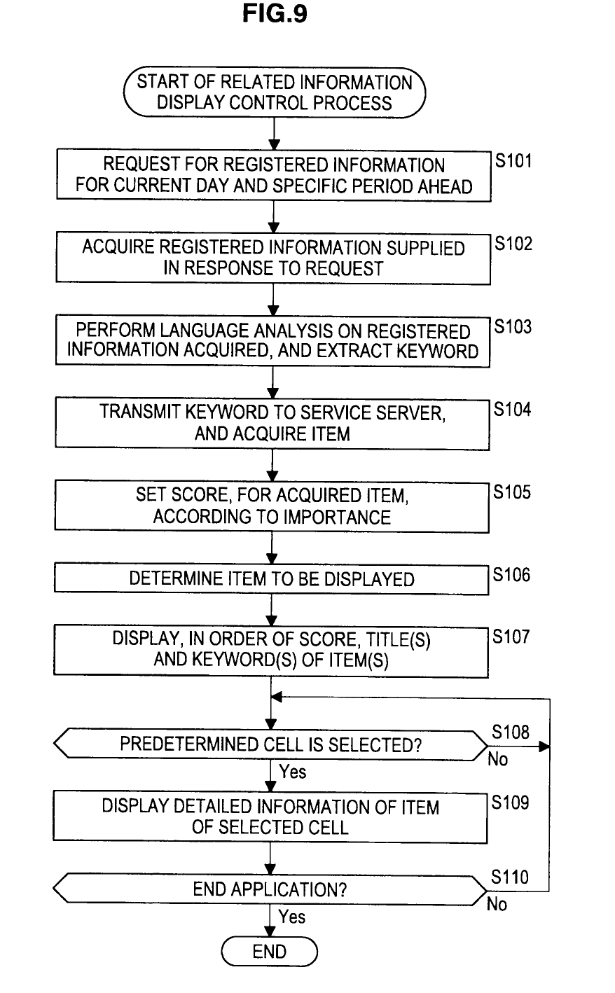

FIG. 9 is a flow chart of the related information display control process performed by the schedule-related information providing unit 62 which is a single application. This process is performed when the schedule-related information providing unit 62 as a single application is started, for example.

First, in step S101, the schedule registration information acquisition unit 71 requests the schedule management unit 61, which is a separate application, for registered information for the current day and a specific period ahead.

In step S102, the schedule registration information acquisition unit 71 acquires registered information that is supplied from the schedule management unit 61 in response to the request.

In step S103, the keyword extraction unit 72 extracts keywords by performing language analysis such as morphological analysis or syntactic analysis on each piece of registered information acquired.

In step S104, the item acquisition unit 73 transmits a keyword extracted by the keyword extraction unit 72 to the service server 3, and acquires an item (related information) related to the keyword, which has been returned as a result. Furthermore, the item acquisition unit 73 causes the item storage unit 76 to store the keyword which has been transmitted, the title of the item acquired by the keyword and the URL of its detailed information.

In step S105, the importance score setting unit 74 sets a score that is in accordance with the importance, for one or more items acquired by the item acquisition unit 73.

The process of steps S104 and S105 are the same as the process of steps S3 and S4 of FIG. 5.

In step S106, the detailed information display control unit 75 determines an item to be displayed based on the score set for each item.

In step S107, the detailed information display control unit 75 displays, on the related information-details display screen 31, the title(s) of the item(s) determined to be displayed and the keyword(s) in the descending order of scores.

In step S108, the detailed information display control unit 75 decides whether a predetermined cell 41 is selected on the related information-details display screen 31. That is, the detailed information display control unit 75 decides whether the keyword and the title of one of a plurality of items displayed on the related information-details display screen 31 is selected.

In step S108, the process is suspended until it is decided that a predetermined cell 41 on the related information-details display screen 31 is selected. Then, in the case it is decided in step S108 that a predetermined cell 41 on the related information-details display screen 31 is selected, the process proceeds to step S109, and the detailed information display control unit 75 displays detailed information of an item of the selected cell 41.

In step S110, the schedule-related information providing unit 62 decides whether an instruction indicating the end of the application is issued. In the case it is decided in step S110 that an instruction indicating the end of the application is not issued, the process returns to step S108, and the process of steps S108 to S110 is repeated.

On the other hand, in the case it is decided in step S110 that an instruction indicating the end of the application is issued, the related information display control process is ended.

As described above, in the case the related information display function is realized as a single application, registered information for a predetermined period is acquired from a normal scheduler (the schedule management unit 61). Then, item(s) related to the registered information acquired is acquired, and the importance is set. Then, the schedule-related information providing unit 62 displays the related information-details display screen 31 displaying the item(s) in an order according to the importance.

Accordingly, a user can view related information related to a registered plan simply by registering a plan in another scheduler (the schedule management unit 61). The burden of the user having to search for related information himself/herself can be thereby eliminated, and the convenience is increased.

Additionally, in the embodiment described above, a case where the mobile terminal 1 uses the viewing state (the number of clicks) of other users accumulated in the application-related server 4 was mainly described. However, the mobile terminal 1 also transmits, for other users, information indicating that the user of the mobile terminal 1 has viewed the details of an item. To be specific, in the case a predetermined cell 41 on the related information-details display screen 31 of FIG. 3 is selected, the schedule-related information providing unit 62 transmits information indicating that an item of the selected cell 41 has been viewed to the application-related server 4.

### Modified Example

The embodiments of the present technology are not limited to those described above, and various changes are possible so long as they are within the scope of the present technology.

In the embodiments described above, the explanation has been given citing the news providing server 3A, the image providing server 3B and the communication service server 3C as the examples of the service server 3.

Other examples of the service server 3 include a Website selling concert tickets or the like, and in this case, information of a concert taking place at a location (place) whose name has been extracted as the keyword may be displayed as the item. Moreover, in the case a website selling CDs and DVDs of musicians is the service server 3, information on a musician whose products have been purchased by the user in the past may be displayed as the item.

Furthermore, in the embodiments described above, the importance of an item is set according to the operation history (the number of clicks) of other users, but the importance of an item may also be set based on the operation history of the user of the mobile terminal 1. For example, viewing history of the user for each class, such as news, video, RSS or twitter, is stored, and the proportion of viewing of each class (the frequency of viewing) is calculated based on, for example, the number of times of viewing of each class against the number of times of viewing of all the classes, and a high importance is set for an item belonging to a class with a high proportion of viewing. Furthermore, the importance may be set by calculating the proportion of viewing for each acquisition source of an item.

In the case of displaying a plurality of items acquired based on keywords, it is expected that the number of items to be acquired will be large, and various methods, as described below, of displaying the items may be adopted.

For example, the detailed information display control unit 75 may record the operation history of a user, and calculate and hold the time the user has spent viewing each item. Then, for example, the detailed information display control unit 75 may cause free time to be input (selection from a predetermined list is also possible) at the time of start of the application, and calculate the number N of items that can be viewed in the free time based on the viewing time, that is held, for each item, and cause it to be the number of items to be displayed (the top N items from the highest score).

The items may be displayed in the manner of a slideshow such that the next item is automatically displayed when the viewing time for one item has elapsed. However, it is important that the user can return to the previous item or proceed to the next item on his/her own accord. Also, the application may be force quitted when the free time is over.

Also, as a method of calculating the free time of the user, the free time of the user may be calculated based on the plan input in the scheduler 51. Also, in the case a navigation device (navigation software) can be used, the time spent waiting for a train or the time spent on the train may be automatically set (by the schedule-related information providing unit 62) as the free time.

To show the related information-details display screen 31 as an animated cartoon, display may be adopted which shows, as an animated cartoon, an egg breaking in accordance with the remaining time of the free time, and when a chick is hatched, the chick eats the titles one by one from the top so as to move to the title of the next item.

In the embodiments described above, the scheduler 51 or the schedule-related information providing unit 62 as add-in software or a single application are described as applications that are to be installed on the mobile terminal 1 and be executed. However, the scheduler 51 or the schedule-related information providing unit 62 may be an application that is to be installed on a desktop personal computer or a web server and be provided to the user.

In the embodiments described above, an item based on a keyword is acquired only from the service server 3, but it may also be acquired from within the mobile terminal 1 or another device in the LAN to which the mobile terminal 1 is connected. For example, a musician of content (video or music file) registered by content management software in the mobile terminal 1 may be taken as the keyword and information on the concerts or a blog related to the musician may be acquired as the item.

[Example Configuration of Computer]

The series of processes described above may be performed by hardware or software. In the case of performing the series of processes by software, programs constituting the software are installed on a computer. The computer here may be a computer that is incorporated in dedicated hardware, a computer that is capable of performing various functions by installing various programs, such as a general-purpose personal computer, or the like.

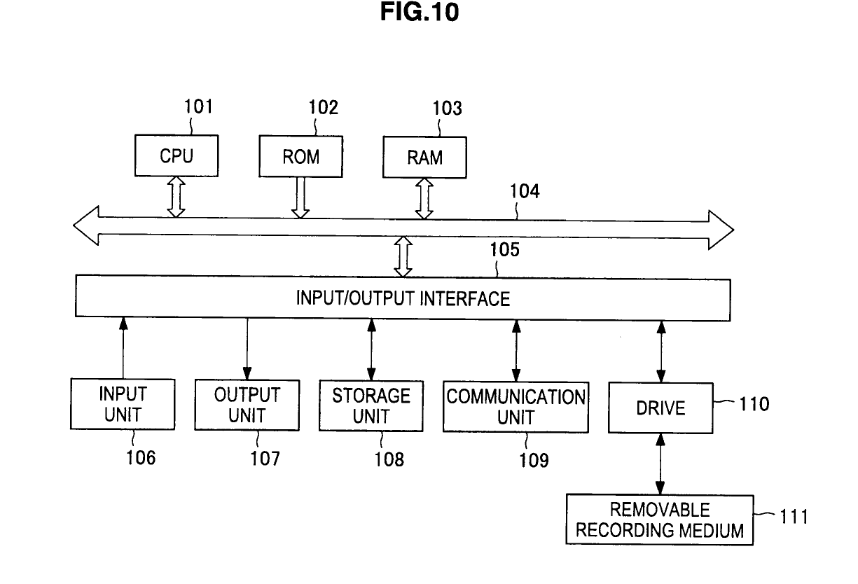

FIG. 10 is a block diagram showing an example configuration of the hardware of a computer that performs the series of processes described above by programs.

In the computer, a CPU (Central Processing Unit) 101, a ROM (Read Only Memory) 102 and a RAM (Random Access Memory) 103 are connected to each other via a bus 104.

An input/output interface 105 is also connected to the bus 104. An input unit 106, an output unit 107, a storage unit 108, a communication unit 109 and a drive 110 are connected to the input/output interface 105.

The input unit 106 is configured from a keyboard, a mouse, a microphone or the like. The output unit 107 is configured from a display, a speaker or the like. The storage unit 108 is configured from a memory such as a hard disk or a non-volatile memory or the like. The communication unit 109 is configured from a network interface or the like. The drive 110 drives a removable recording medium 111 such as a magnetic disk, an optical disk, a magneto-optical disk, a semiconductor memory or the like.

With the computer configured in the above manner, the series of processes described above is performed by the CPU 101 loading the programs stored in the storage unit 108 on the RAM 103 via the input/output interface 105 and the bus 104 and executing the same, for example.

According to the computer, programs can be installed on the storage unit 108 via the input/output interface 105 by attaching the removable recording medium 111 to the drive 110. Also, programs can be received by the communication unit 109 via a wired or wireless transmission medium, such as a local area network, the Internet or digital satellite broadcasting, and be installed on the storage unit 108. Moreover, programs can be installed in advance in the ROM 102 or the storage unit 108.

In the present specification, the steps described in the flow charts can, of course, be processed chronologically according to the described order, but they can also be performed in parallel or at necessary timing, such as when there is a call up, without being processed chronologically.

It should be understood by those skilled in the art that various modifications, combinations, sub-combinations and alterations may occur depending on design requirements and other factors insofar as they are within the scope of the appended claims or the equivalents thereof.

Additionally, in the present specification, a system indicates the entire apparatus configured from a plurality of apparatuses.

Additionally, the present technology may also be configured as below.

(1)

An information processing apparatus including:

a related information acquisition unit for acquiring related information related to registered information registered in a schedule; and

a display control unit for causing the related information, which has been acquired, to be displayed on a predetermined display unit according to an importance.

(2)

The information processing apparatus according to (1) described above, further including:

a registered information acquisition unit for acquiring the registered information registered for a current day to a specific period ahead from a scheduler managing the schedule.

(3)

The information processing apparatus according to (1) or (2) described above, further including:

a keyword extraction unit for extracting a keyword from the registered information,

wherein the related information acquisition unit acquires the related information related to the registered information by acquiring information related to the keyword extracted from the registered information.

(4)

The information processing apparatus according to (3) described above, wherein the related information is information including, in a title or description, the keyword.

(5)

The information processing apparatus according to any of (2) to (4) described above, further including:

an importance setting unit for setting the importance for the related information acquired by the related information acquisition unit.

(6)

The information processing apparatus according to (5) described above, wherein the importance setting unit sets the importance that is in accordance with a state of viewing of another user.

(7)

The information processing apparatus according to any of (2) to (6) described above, further including:

a scheduler for displaying on a calendar a plan of a user, which is the registered information.

(8)

An information processing method, performed by an information processing apparatus, including a related information acquisition unit and a display control unit, that processes information registered in a schedule, including:

acquiring, by the related information acquisition unit, related information related to registered information registered in the schedule; and

displaying, by the display control unit, the related information, which has been acquired, on a predetermined display unit according to an importance.

(9)

A program for causing a computer to execute a process including:

acquiring related information related to registered information registered in a schedule; and

causing the related information, which has been acquired, to be displayed on a predetermined display unit according to an importance.

The present disclosure contains subject matter related to that disclosed in Japanese Priority Patent Application JP 2011-095016 filed in the Japan Patent Office on Apr. 21, 2011, the entire content of which is hereby incorporated by reference.

What is claimed is:

1. An information processing apparatus comprising:
a related information acquisition unit for acquiring related information related to registered information registered in a schedule; and
a display control unit for causing the related information, which has been acquired, to be displayed on a predetermined display unit according to an importance.

2. The information processing apparatus according to claim 1, further comprising:
a registered information acquisition unit for acquiring the registered information registered for a current day to a specific period ahead from a scheduler managing the schedule.

3. The information processing apparatus according to claim 1, further comprising:
a keyword extraction unit for extracting a keyword from the registered information,
wherein the related information acquisition unit acquires the related information related to the registered information by acquiring information related to the keyword extracted from the registered information.

4. The information processing apparatus according to claim 3, wherein the related information is information including, in a title or description, the keyword.

5. The information processing apparatus according to claim 1, further comprising:
an importance setting unit for setting the importance for the related information acquired by the related information acquisition unit.

6. The information processing apparatus according to claim 5, wherein the importance setting unit sets the importance that is in accordance with a state of viewing of another user.

7. The information processing apparatus according to claim 1, further comprising:
a scheduler for displaying on a calendar a plan of a user, which is the registered information.

8. An information processing method, performed by an information processing apparatus, including a related information acquisition unit and a display control unit, that processes information registered in a schedule, comprising:
acquiring, by the related information acquisition unit, related information related to registered information registered in the schedule; and
displaying, by the display control unit, the related information, which has been acquired, on a predetermined display unit according to an importance.

9. A program for causing a computer to execute a process including:
acquiring related information related to registered information registered in a schedule; and
causing the related information, which has been acquired, to be displayed on a predetermined display unit according to an importance.
